(19) United States
(12) Patent Application Publication
(10) Pub. No.: US 2023/0122185 A1
(43) Pub. Date: Apr. 20, 2023

(54) DETERMINING RELATIVE POSITION AND ORIENTATION OF CAMERAS USING HARDWARE

(71) Applicant: Microsoft Technology Licensing, LLC, Redmond, WA (US)

(72) Inventors: Raymond Kirk PRICE, Redmond, WA (US); Michael BLEYER, Seattle, WA (US); Christopher Douglas EDMONDS, Carnation, WA (US); Carlos Andre TAVARES CAMPOS, Seattle, WA (US)

(21) Appl. No.: 17/504,123

(22) Filed: Oct. 18, 2021

(51) Int. Cl. H04N 13/156; G06T 7/593; G06T 7/521; H04N 13/332; H04N 13/243; H04N 13/271; G06T 7/30; G02B 27/01; G01B 11/22; G01C 3/02

(52) U.S. Cl. CPC H04N 13/156; G06T 7/593; G06T 7/521; H04N 13/332; H04N 13/243; H04N 13/271; G06T 7/30; G02B 27/0172; G01B 11/22; G01C 3/02; G06T 2207/10012; G06T 2207/10028; G06T 2207/30244; G02B 2027/0178; G02B 2027/014; G02B 2027/0138

(57) ABSTRACT

Techniques for performing a hardware-based image alignment process are disclosed. A relative position and orientation between a system camera and a detached external camera are determined. This process is performed using 6 degree of freedom (DOF) trackers on the system camera and on the external camera. A depth measurement, which indicates a distance between the external camera and a scene where the external camera is aimed, is obtained. The system camera generates a system camera image, and the external camera generates an image. An overlaid image is generated by using the relative position and orientation and the depth measurement to reproject the second content onto the first content.

### BACKGROUND

Mixed-reality (MR) systems, which include virtual-reality (VR) and augmented-reality (AR) systems, have received significant attention because of their ability to create truly unique experiences for their users. For reference, conventional VR systems create completely immersive experiences by restricting their users' views to only virtual environments. This is often achieved through the use of a head mounted device (HMD) that completely blocks any view of the real world. As a result, a user is entirely immersed within the virtual environment. In contrast, conventional AR systems create an augmented-reality experience by visually presenting virtual objects that are placed in or that interact with the real world.

As used herein, VR and AR systems are described and referenced interchangeably. Unless stated otherwise, the descriptions herein apply equally to all types of MR systems, which (as detailed above) include AR systems, VR reality systems, and/or any other similar system capable of displaying virtual content.

A MR system may also employ different types of cameras in order to display content to users, such as in the form of a passthrough image. A passthrough image or view can aid users in avoiding disorientation and/or safety hazards when transitioning into and/or navigating within a MR environment. A MR system can present views captured by cameras in a variety of ways. The process of using images captured by world-facing cameras to provide views of a real-world environment creates many challenges, however.

Some of these challenges occur when attempting to align image content from multiple cameras, such as an integrated “system camera” and a detached “external camera” when generating the passthrough image. Challenges also occur when additional visualizations are provided in the resulting overlaid passthrough image, where these visualizations are designed to indicate a spatial relationship between the system camera and the external camera. The time taken to i) generate a system camera image and an external camera image, ii) overlay and align the content, and then iii) display the resulting overlaid passthrough image with additional visualizations is not instantaneous. Because of that, movement of the system camera and/or the external camera may occur between the time when the images are generated and when the final passthrough image is displayed. Such movement results in a visible latency or lagging effect and is disruptive to the user. Additionally, traditional techniques often relied on inadequate images when attempting to perform the alignment operations. Because of these inadequate images, the alignment process would often fail, and other techniques would need to be performed to provide the overlaid image. Accordingly, aligning image content provides substantial benefits, especially in terms of hologram placement and generation, so these problems present serious obstacles to the technical field. As such, there is a substantial need in the field to improve how images are aligned with one another.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

Embodiments disclosed herein relate to systems, devices (e.g., wearable devices, hardware storage devices, etc.), and methods for determining a relative position and orientation between a system camera and an external camera. In effect, the disclosed embodiments rely on a hardware-based approach to assist with the image alignment process, and this new approach can be performed essentially in real-time and can be performed even when traditional solutions would otherwise fail (e.g., poor lighting conditions).

Some embodiments determine a relative position and orientation between a system camera and a detached external camera. The process of determining the relative position and orientation is performed using a 6 degree of freedom (DOF) tracker on the system camera and a 6 DOF tracker on the external camera. A depth measurement, which indicates a distance between the external camera and a scene where the external camera is aimed, is obtained. The embodiments use the system camera to generate a system camera image. Relatedly, the embodiments obtain an external camera image from the external camera. The embodiments also generate an overlaid image by using the relative position and orientation in combination with the depth measurement to reproject the second content from the external camera image onto the first content included in the system camera image. Optionally, that overlaid image is displayed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example head mounted device (HMD) configured to perform the disclosed operations.

FIG. 2 illustrates another configuration of an HMD.

FIG. 3 illustrates an example scenario in which the disclosed principles may be practiced.

FIG. 4 illustrates another example scenario.

FIG. 5 illustrates how a system camera and an external camera can be used to perform the disclosed operations.

FIG. 6 illustrates the field of view (FOV) of a system camera.

FIG. 7 illustrates the FOV of an external camera.

FIG. 8 illustrates an overlaid and aligned image in which image content from the external camera image is overlaid onto the system camera image.

FIG. 9 illustrates another example scenario in which the principles may be practiced.

FIG. 10 illustrates how an external camera image can be overlaid onto a system camera image using a visual alignment process and how a bounding element can be displayed in a manner so as to surround the content from the external camera image.

FIG. 11 illustrates how, during time periods where visual alignment processes are not performed (e.g., perhaps because an insufficient number of feature points were detected to perform visual alignment, perhaps because of insufficient lighting conditions, etc.), IMUs can be used to track movements of the system camera and/or the external camera in order to align content and in order to shift the position of the bounding element.

FIG. 12 illustrates how a 6 DOF tracker can be installed on the HMD (proximate or with the system camera) and how a 6 DOF tracker can be installed on the tool (proximate or with the external camera). A range finder can also be installed on the tool (proximate or with the external camera). Through use of the 6 DOF trackers and the range finder, the disclosed embodiments can accurately determine the relative position and orientation of the cameras relative to one another. Such information can then be used to perform an image alignment process.

FIG. 13 illustrates an example scenario where information describing a relative position and orientation of the cameras and information describing the distance of the external camera to an object in the scene are used to align image content.

FIG. 14 illustrates an abstracted view of the image alignment process.

FIG. 15 illustrates a flowchart of an example method for determining the position and orientation of cameras in order to facilitate an image alignment process using a hardware-based approach.

FIG. 16 illustrates an example computer system capable of performing any of the disclosed operations.

### DETAILED DESCRIPTION

Embodiments disclosed herein relate to systems, devices (e.g., wearable devices, hardware storage devices, etc.), and methods for determining a relative position and orientation between a system camera and an external camera.

Some embodiments determine a relative position and orientation between a system camera and a detached external camera. The process of determining the relative position and orientation is performed using 6 degree of freedom (DOF) trackers on the system camera and on the external camera. A depth measurement, which indicates a distance between the external camera and a scene where the external camera is aimed, is obtained. The system camera generates a system camera image, and the external camera generates an image. The embodiments also generate an overlaid image by using the relative position and orientation in combination with the depth measurement to reproject the second content from the external camera image onto the first content included in the system camera image. Optionally, that overlaid image is displayed.

Examples Of Technical Benefits, Improvements, And Practical Applications

The following section outlines some example improvements and practical applications provided by the disclosed embodiments. It will be appreciated, however, that these are just examples only and that the embodiments are not limited to only these improvements.

As described earlier, challenges occur when aligning image content from two different cameras. Generally, there are a few techniques that can be used to align images. One technique is referred to herein as a “visual alignment” technique. This technique involves identifying feature points in one image and corresponding feature points in another image. The technique then involves aligning the images using the common feature points as references. Another technique involves the use of IMU data to track and monitor how one camera shifts in pose and orientation relative to another camera (i.e. an “IMU-based” approach). The orientation models for the cameras can be modified based on the IMU data, and the resulting images can be reprojected in order to align with one another.

It is typically the case that IMU data is readily available, so performing the IMU-based correction is usually an option, but it is often less accurate than the visual alignment technique. The visual alignment technique, on the other hand, might not always be available. For instance, it is sometimes the case that a sufficient number of feature points are not detectable or that the lighting conditions are not adequate. What often results then is a hybrid approach in which IMU data is relied on to perform the alignment when the visual alignment process is not available.

Differences exist in the timing as to when the system camera generates images, when the external camera generates images, and even when the visual alignment process is performed. For example, it is often the case that the system camera operates at a frame per second (FPS) rate of at least 60 FPS, and it is often the case that the external camera operates at a FPS rate of at least 30 FPS. The visual alignment process, on the other hand, is often triggered or executed at about 3 Hz. What this means, then, is that there can be a delay in when and how the aligning process is performed.

The disclosed embodiments provide solutions to these problems by performing a non-visual based alignment process, which can be performed substantially in real-time. That is, in accordance with the disclosed principles, the embodiments utilize a hardware-based approach in acquiring information that is then used to align the resulting images. Because the operations rely on hardware, the speed by which the operations are performed is almost instantaneous. Additionally, the disclosed operations can be performed even when other solutions might fail, such as in the case where the lighting conditions are too low to detect a sufficient number of feature points in an image. In this sense, the disclosed operations are non-visual based operations as opposed to visual-based operations (as is the case with the visual alignment process). Furthermore, the disclosed operations produce results that are more accurate than the IMU-based approach.

As a result of performing these operations, the user's experience is significantly improved, thereby leading to an improvement in the technology. Improved image alignment and visualization are also achieved. Accordingly, these and numerous other benefits will be described throughout the remaining portions of this disclosure.

Example MR Systems And HMDs

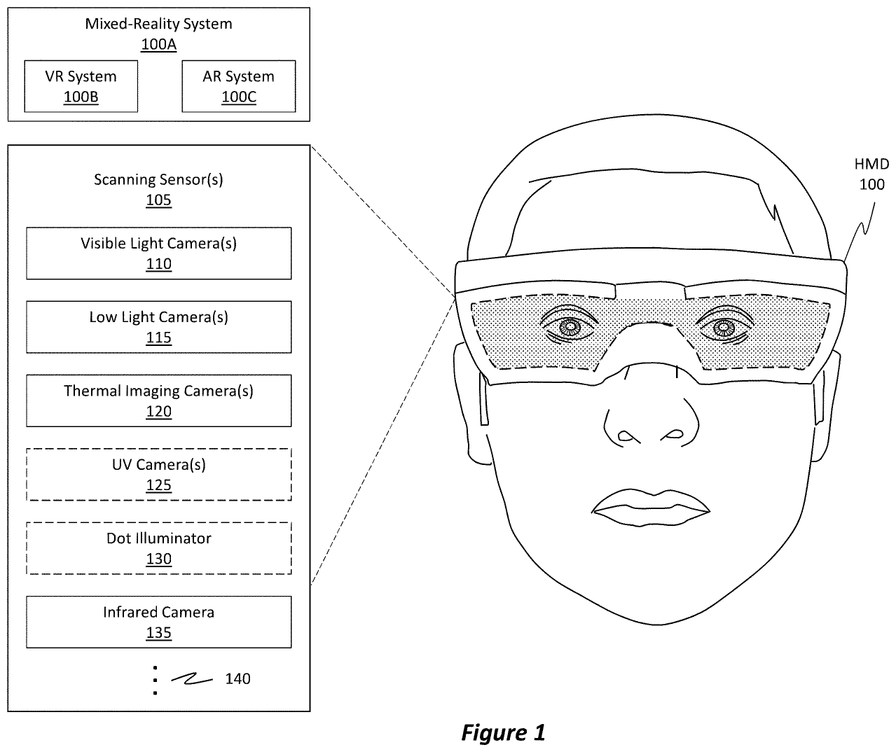

Attention will now be directed to FIG. 1, which illustrates an example of a head mounted device (HMD) 100. HMD 100 can be any type of MR system 100A, including a VR system 100B or an AR system 100C. It should be noted that while a substantial portion of this disclosure is focused on the use of an HMD, the embodiments are not limited to being practiced using only an HMD. That is, any type of camera system can be used, even camera systems entirely removed or separate from an HMD. As such, the disclosed principles should be interpreted broadly to encompass any type of camera use scenario. Some embodiments may even refrain from actively using a camera themselves and may simply use the data generated by a camera. For instance, some embodiments may at least be partially practiced in a cloud computing environment.

HMD 100 is shown as including scanning sensor(s) 105 (i.e. a type of scanning or camera system), and HMD 100 can use the scanning sensor(s) 105 to scan environments, map environments, capture environmental data, and/or generate any kind of images of the environment (e.g., by generating a 3D representation of the environment or by generating a “passthrough” visualization). Scanning sensor(s) 105 may comprise any number or any type of scanning devices, without limit.

In accordance with the disclosed embodiments, the HMD 100 may be used to generate a passthrough visualizations of the user's environment. As used herein, a “passthrough” visualization refers to a visualization that reflects the perspective of the environment from the user's point of view. To generate this passthrough visualization, the HMD 100 may use its scanning sensor(s) 105 to scan, map, or otherwise record its surrounding environment, including any objects in the environment, and to pass that data on to the user to view. As will be described shortly, various transformations may be applied to the images prior to displaying them to the user to ensure the displayed perspective matches the user's expected perspective.

To generate a passthrough image, the scanning sensor(s) 105 typically rely on its cameras (e.g., head tracking cameras, hand tracking cameras, depth cameras, or any other type of camera) to obtain one or more raw images (aka “texture images”) of the environment. In addition to generating passthrough images, these raw images may also be used to determine depth data detailing the distance from the sensor to any objects captured by the raw images (e.g., a z-axis range or measurement). Once these raw images are obtained, then a depth map can be computed from the depth data embedded or included within the raw images (e.g., based on pixel disparities), and passthrough images can be generated (e.g., one for each pupil) using the depth map for any reprojections, if needed.

From the passthrough visualizations, a user will be able to perceive what is currently in his/her environment without having to remove or reposition the HMD 100. Furthermore, as will be described in more detail later, the disclosed passthrough visualizations can also enhance the user's ability to view objects within his/her environment (e.g., by displaying additional environmental conditions that may not have been detectable by a human eye). As used herein, a so-called “overlaid image” can be a type of passthrough image.

It should be noted that while the majority of this disclosure focuses on generating “a” passthrough image, the embodiments actually generate a separate passthrough image for each one of the user's eyes. That is, two passthrough images are typically generated concurrently with one another. Therefore, while frequent reference is made to generating what seems to be a single passthrough image, the embodiments are actually able to simultaneously generate multiple passthrough images.

In some embodiments, scanning sensor(s) 105 include visible light camera(s) 110, low light camera(s) 115, thermal imaging camera(s) 120, potentially (though not necessarily, as represented by the dotted box in FIG. 1) ultraviolet (UV) camera(s) 125, potentially (though not necessarily, as represented by the dotted box) a dot illuminator 130, and even an infrared camera 135. The ellipsis 140 demonstrates how any other type of camera or camera system (e.g., depth cameras, time of flight cameras, virtual cameras, depth lasers, etc.) may be included among the scanning sensor(s) 105.

As an example, a camera structured to detect mid-infrared wavelengths may be included within the scanning sensor(s) 105. As another example, any number of virtual cameras that are reprojected from an actual camera may be included among the scanning sensor(s) 105 and may be used to generate a stereo pair of images. In this manner, the scanning sensor(s) 105 may be used to generate the stereo pair of images. In some cases, the stereo pair of images may be obtained or generated as a result of performing any one or more of the following operations: active stereo image generation via use of two cameras and one dot illuminator (e.g., dot illuminator 130); passive stereo image generation via use of two cameras; image generation using structured light via use of one actual camera, one virtual camera, and one dot illuminator (e.g., dot illuminator 130); or image generation using a time of flight (TOF) sensor in which a baseline is present between a depth laser and a corresponding camera and in which a field of view (FOV) of the corresponding camera is offset relative to a field of illumination of the depth laser.

The visible light camera(s) 110 are typically stereoscopic cameras, meaning that the fields of view of the two or more visible light cameras at least partially overlap with one another. With this overlapping region, images generated by the visible light camera(s) 110 can be used to identify disparities between certain pixels that commonly represent an object captured by both images. Based on these pixel disparities, the embodiments are able to determine depths for objects located within the overlapping region (i.e. “stereoscopic depth matching” or “stereo depth matching”). As such, the visible light camera(s) 110 can be used to not only generate passthrough visualizations, but they can also be used to determine object depth. In some embodiments, the visible light camera(s) 110 can capture both visible light and IR light.

It should be noted that any number of cameras may be provided on the HMD 100 for each of the different camera types (aka modalities). That is, the visible light camera(s) 110 may include 1, 2, 3, 4, 5, 6, 7, 8, 9, 10, or more than 10 cameras. Often, however, the number of cameras is at least 2 so the HMD 100 can perform passthrough image generation and/or stereoscopic depth matching, as described earlier. Similarly, the low light camera(s) 115, the thermal imaging camera(s) 120, and the UV camera(s) 125 may each respectively include 1, 2, 3, 4, 5, 6, 7, 8, 9, 10, or more than 10 corresponding cameras.

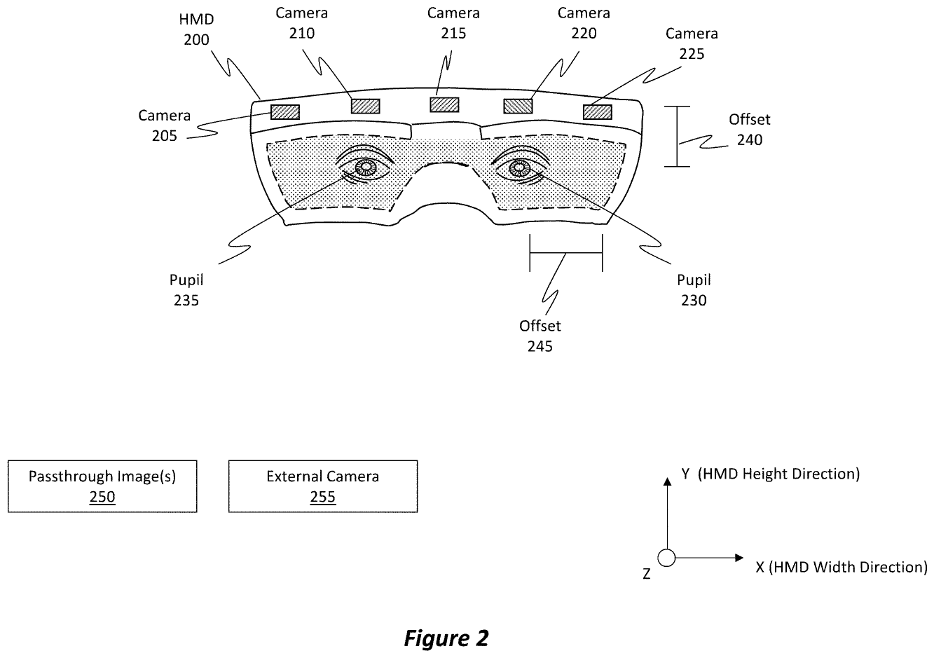

FIG. 2 illustrates an example HMD 200, which is representative of the HMD 100 from FIG. 1. HMD 200 is shown as including multiple different cameras, including cameras 205, 210, 215, 220, and 225. Cameras 205-225 are representative of any number or combination of the visible light camera(s) 110, the low light camera(s) 115, the thermal imaging camera(s) 120, and the UV camera(s) 125 from FIG. 1. While only 5 cameras are illustrated in FIG. 2, HMD 200 may include more or less than 5 cameras. Any one of those cameras can be referred to as a “system camera.”

In some cases, the cameras can be located at specific positions on the HMD 200. In some cases, a first camera (e.g., perhaps camera 220) is disposed on the HMD 200 at a position above a designated left eye position of a user who wears the HMD 200 relative to a height direction of the HMD. For example, the camera 220 is positioned above the pupil 230. As another example, the first camera (e.g., camera 220) is additionally positioned above the designated left eye position relative to a width direction of the HMD. That is, the camera 220 is positioned not only above the pupil 230 but also in-line relative to the pupil 230. When a VR system is used, a camera may be placed directly in front of the designated left eye position. With reference to FIG. 2, a camera may be physically disposed on the HMD 200 at a position in front of the pupil 230 in the z-axis direction.

When a second camera is provided (e.g., perhaps camera 210), the second camera may be disposed on the HMD 200 at a position above a designated right eye position of a user who wears the HMD relative to the height direction of the HMD. For example, the camera 210 is above the pupil 235. In some cases, the second camera is additionally positioned above the designated right eye position relative to the width direction of the HMD. When a VR system is used, a camera may be placed directly in front of the designated right eye position. With reference to FIG. 2, a camera may be physically disposed on the HMD 200 at a position in front of the pupil 235 in the z-axis direction.

When a user wears HMD 200, HMD 200 fits over the user's head and the HMD 200's display is positioned in front of the user's pupils, such as pupil 230 and pupil 235. Often, the cameras 205-225 will be physically offset some distance from the user's pupils 230 and 235. For instance, there may be a vertical offset in the HMD height direction (i.e. the “Y” axis), as shown by offset 240. Similarly, there may be a horizontal offset in the HMD width direction (i.e. the “X” axis), as shown by offset 245.

HMD 200 is configured to provide passthrough image(s) 250 for the user of HMD 200 to view. In doing so, HMD 200 is able to provide a visualization of the real world without requiring the user to remove or reposition HMD 200. These passthrough image(s) 250 effectively represent the view of the environment from the HMD's perspective. Cameras 205-225 are used to provide these passthrough image(s) 250. The offset (e.g., offset 240 and 245) between the cameras and the user's pupils results in parallax. In order to provide these passthrough image(s) 250, the embodiments can perform parallax correction by applying various transformations and reprojections on the images in order to change the initial perspective represented by an image into a perspective matches that of the user's pupils. Parallax correction relies on the use of a depth map in order to make the reprojections.

In some implementations, the embodiments utilize a planar reprojection process to correct parallax when generating the passthrough images as opposed to performing a full three-dimensional reprojection. Using this planar reprojection process is acceptable when objects in the environment are sufficiently far away from the HMD. Thus, in some cases, the embodiments are able to refrain from performing three-dimensional parallax correction because the objects in the environment are sufficiently far away and because that distance results in a negligible error with regard to depth visualizations or parallax issues.

Any of the cameras 205-225 constitute what is referred to as a “system camera” because they are integrated parts of the HMD 200. In contrast, the external camera 255 is physically separate and detached from the HMD 200 but can communicate wirelessly with the HMD 200. As will be described shortly, it is desirable to align images (or image content) generated by the external camera 255 with images (or image content) generated by a system camera to then generate an overlaid image, which can operate as a passthrough image. Often, the angular resolution of the external camera 255 is higher (i.e. more pixels per degree and not just more pixels) than the angular resolution of the system camera, so the resulting overlaid image provides enhanced image content beyond that which is available from using only the system camera image. Additionally, or alternatively, the modalities of the external camera 255 and the system camera may be different, so the resulting overlaid image can also include enhanced information. As an example, suppose the external camera 255 is a thermal imaging camera. The resulting overlaid image can, therefore, include visible light image content and thermal image content. Accordingly, providing an overlaid passthrough image is highly desirable. It should be noted that the external camera 255 may be any of the camera types listed earlier. Additionally, there may be any number of external cameras, without limit.

Example Scenarios

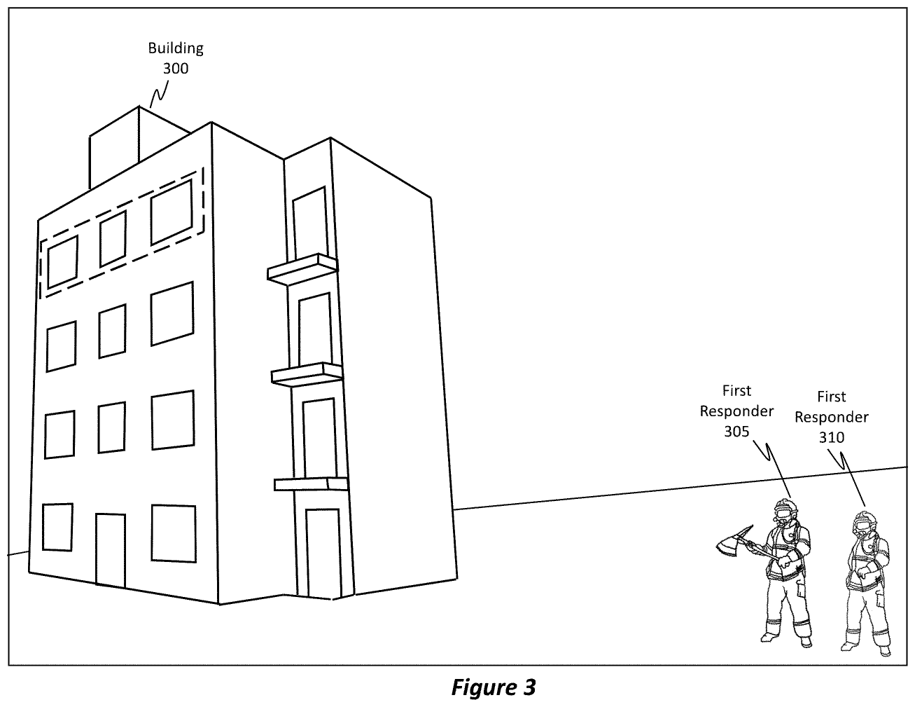

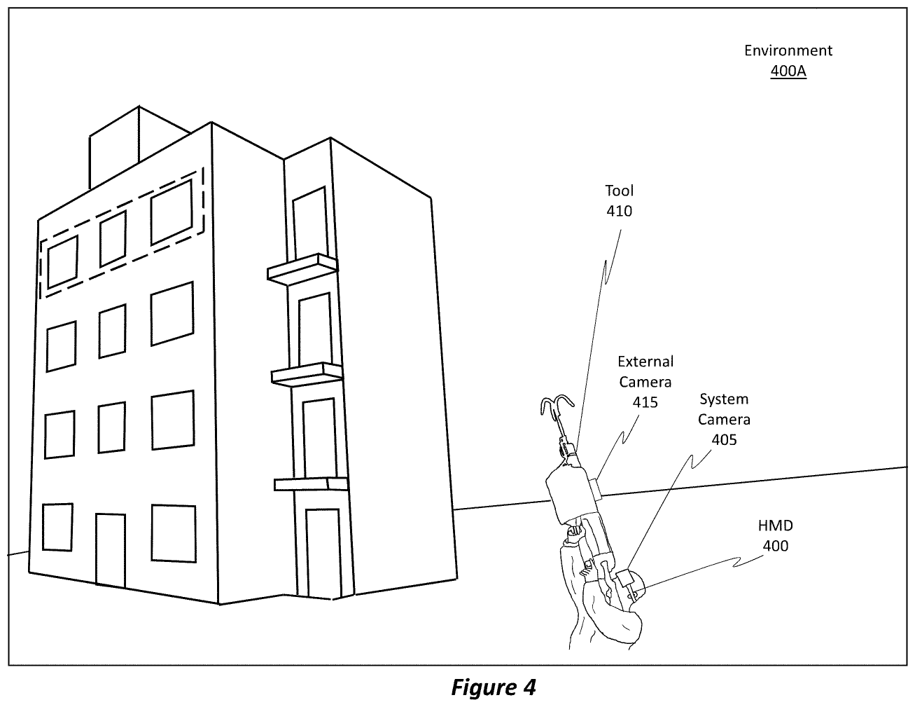

Attention will now be directed to FIG. 3, which illustrates an example scenario in which the HMDs discussed in FIGS. 1 and 2 may be used. FIG. 3 shows a building 300 and a first responder 305 and another first responder 310. In this example scenario, the first responders 305 and 310 are desirous to scale the building 300. FIG. 4 shows one example technique for performing this scaling feat.

FIG. 4 shows a first responder wearing an HMD 400, which is representative of the HMDs discussed thus far, in an environment 400A. HMD 400 includes a system camera 405, as discussed previously. Furthermore, the first responder is using a tool 410 that includes an external camera 415, which is representative of the external camera 255 of FIG. 2. In this case, the tool 410 is a grappling gun that will be used to shoot a rope and hook onto the building to allow the first responder to scale the building. By aligning the image content generated by the external camera 415 with the image content generated by the system camera 405, the user will be able to better discern where the tool 410 is being aimed.

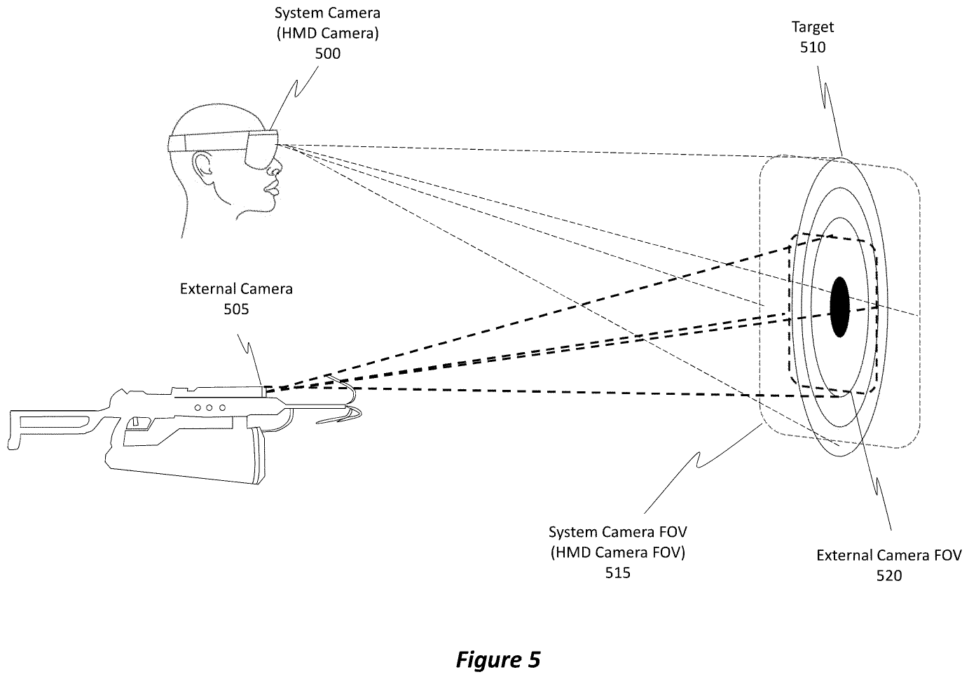

That is, in accordance with the disclosed principles, it is desirable to provide an improved platform or technique by which a user (e.g., the first responders) can aim a tool (e.g., the tool 410) using the HMD 400, the system camera 405, and the external camera 415 as a combined aiming interface. FIG. 5 shows one such example.

FIG. 5 shows a system camera 500 (aka HMD camera) mounted on an HMD, where the system camera 500 is representative of the system camera 405 of FIG. 4, and a tool (e.g., a grappling gun) that includes an external camera 505, which is representative of the external camera 415. It should be noted how the optical axis of the external camera 505 is aligned with the aiming direction of the tool. As a consequence, the images generated by the external camera 505 can be used to determine where the tool is being aimed. One will appreciate how the tool can be any type of aimable tool, without limit.

In FIG. 5, both the system camera 500 and the external camera 505 are being aimed at a target 510. To illustrate, the field of view (FOV) of the system camera 500 is represented by the system camera FOV 515 (aka HMD camera FOV), and the FOV of the external camera 505 is represented by the external camera FOV 520. Notice, the system camera FOV 515 is larger than the external camera FOV 520. Typically, the external camera 505 provides a very focused view, similar to that of a scope (i.e. a high level of angular resolution). As will be discussed in more detail later, the external camera 505 sacrifices a wide FOV for an increased resolution and increased pixel density. Accordingly, in this example scenario, one can observe how in at least some situations, the external camera FOV 520 may be entirely overlapped or encompassed by the system camera FOV 515. Of course, in the event the user aims the external camera 505 in a direction where the system camera 500 is not aimed at, then the system camera FOV 515 and the external camera FOV 520 will not overlap.

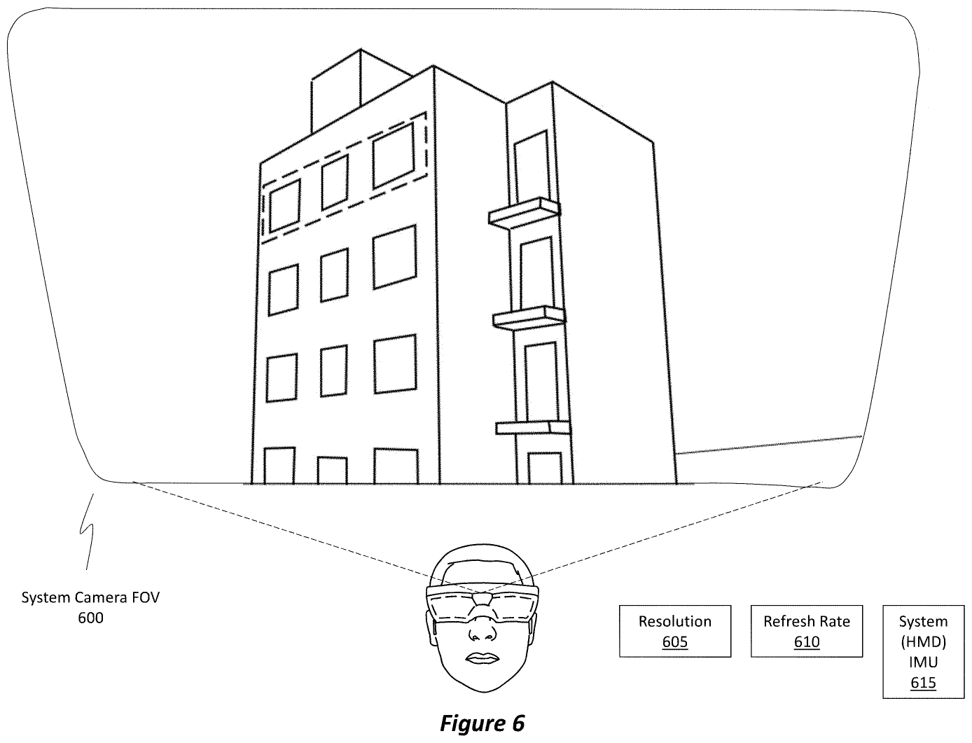

FIG. 6 shows the system camera FOV 600, which is representative of the system camera FOV 515 of FIG. 5. The system camera FOV 600 will be captured by the system camera in the form of a system camera image and will potentially be displayed in the form of a passthrough image. The system camera images have a resolution 605 and are captured by the system camera based on a determined refresh rate 610 of the system camera. The refresh rate 610 of the system camera is typically between about 30 Hz and 120 Hz. Often, the refresh rate 610 is around 90 Hz or at least 60 Hz. Often, the system camera FOV 600 has at least a 55 degree horizontal FOV. The horizontal baseline of the system camera FOV 600 may extend to 65 degrees, or even beyond 65 degrees.

It should also be noted how the HMD includes a system (HMD) inertial measurement unit IMU 615. An IMU (e.g., system IMU 615) is a type of device that measures forces, angular rates, and orientations of a body. An IMU can use a combination of accelerometers, magnetometers, and gyroscopes to detect these forces. Because both the system camera and the system IMU 615 are integrated with the HMD, the system IMU 615 can be used to determine the orientation or pose of the system camera (and the HMD) as well as any forces the system camera is being subjected to.

In some cases, the “pose” may include information detailing the 6 degrees of freedom, or “6 DOF,” information. Generally, the 6 DOF pose refers to the movement or position of an object in three-dimensional space. The 6 DOF pose includes surge (i.e. forward and backward in the x-axis direction), heave (i.e. up and down in the z-axis direction), and sway (i.e. left and right in the y-axis direction). In this regard, 6 DOF pose refers to the combination of 3 translations and 3 rotations. Any possible movement of a body can be expressed using the 6 DOF pose.

In some cases, the pose may include information detailing the 3 DOF pose. Generally, the 3 DOF pose refers to tracking rotational motion only, such as pitch (i.e. the transverse axis), yaw (i.e. the normal axis), and roll (i.e. the longitudinal axis). The 3 DOF pose allows the HMD to track rotational motion but not translational movement of itself and of the system camera. As a further explanation, the 3 DOF pose allows the HMD to determine whether a user (who is wearing the HMD) is looking left or right, whether the user is rotating his/her head up or down, or whether the user is pivoting left or right. In contrast to the 6 DOF pose, when 3 DOF pose is used, the HMD is not able to determine whether the user (or system camera) has moved in a translational manner, such as by moving to a new location in the environment.

Determining the 6 DOF pose and the 3 DOF pose can be performed using inbuilt sensors, such as accelerometers, gyroscopes, and magnetometers (i.e. the system IMU 615). Determining the 6 DOF pose can also be performed using positional tracking sensors, such as head tracking sensors. Accordingly, the system IMU 615 can be used to determine the pose of the HMD.

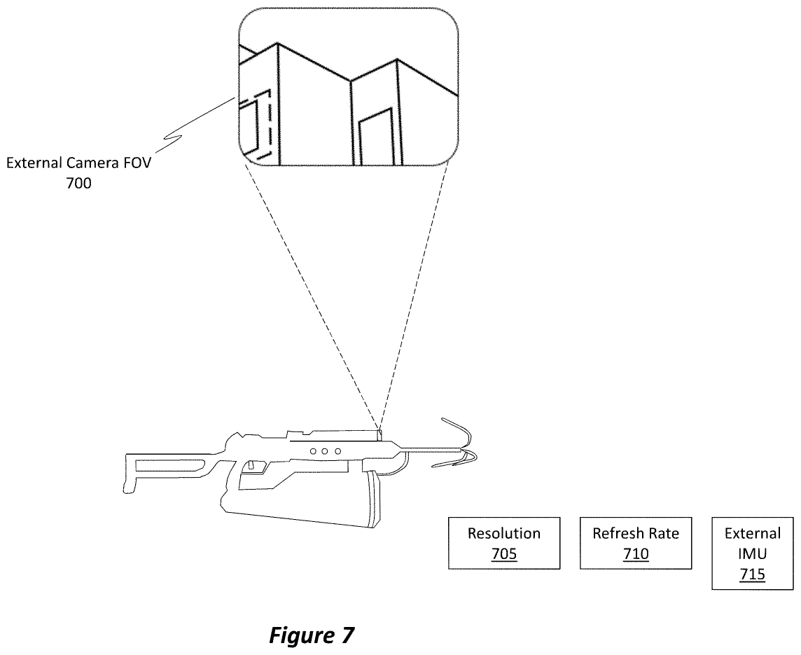

FIG. 7 shows an external camera FOV 700, which is representative of the external camera FOV 520 of FIG. 5. Notice, the external camera FOV 700 is smaller than the system camera FOV 600. That is, the angular resolution of the external camera FOV 700 is higher than the angular resolution of the system camera FOV 600. Having an increased angular resolution also results in the pixel density of an external camera image being higher than the pixel density of a system camera image. For instance, the pixel density of an external camera image is often 2.5 to 3 times that of the pixel density of a system camera image. As a consequence, the resolution 705 of an external camera image is higher than the resolution 605. Often, the external camera FOV 700 has at least a 19 degree horizontal FOV. That horizontal baseline may be higher, such as 20 degrees, 25 degrees, 30 degrees, or more than 30 degrees.

The external camera also has a refresh rate 710. The refresh rate 710 is typically lower than the refresh rate 610. For example, the refresh rate 710 of the external camera is often between 20 Hz and 60 Hz. Typically, the refresh rate 710 is at least about 30 Hz. The refresh rate of the system camera is often different than the refresh rate of the external camera. In some cases, however, the two refresh rates may be substantially the same.

The external camera also includes or is associated with an external IMU 715. Using this external IMU 715, the embodiments are able to detect or determine the orientation/pose of the external camera as well as any forces that the external camera is being subjected to. Accordingly, similar to the earlier discussion, the external IMU 715 can be used to determine the pose (e.g., 6 DOF and/or 3 DOF) of the external camera sight.

In accordance with the disclosed principles, it is desirable to overlap and align the images obtained from the external camera with the images generated by the system camera to generate an overlaid and aligned passthrough image. The overlap between the two images enables the embodiments to generate multiple images and then overlay image content from one image onto another image in order to generate a composite image or an overlaid image having enhanced features that would not be present if only a single image were used. As one example, the system camera image provides a broad FOV while the external camera image provides high resolution and pixel density for a focused area (i.e. the aiming area where the tool is being aimed). By combining the two images, the resulting image will have the benefits of a broad FOV and a high pixel density for the aiming area.

It should be noted that while this disclosure primarily focuses on the use of two images (e.g., the system camera image and the external camera image), the embodiments are able to align content from more than two images having overlapping regions. For instance, suppose 2, 3, 4, 5, 6, 7, 8, 9, or even 10 integrated and/or detached cameras have overlapping FOVs. The embodiments are able to examine each resulting image and then align specific portions with one another. The resulting overlaid image may then be a composite image formed from any combination or alignment of the available images (e.g., even 10 or more images, if available). Accordingly, the embodiments are able to utilize any number of images when performing the disclosed operations and are not limited to only two images or two cameras.

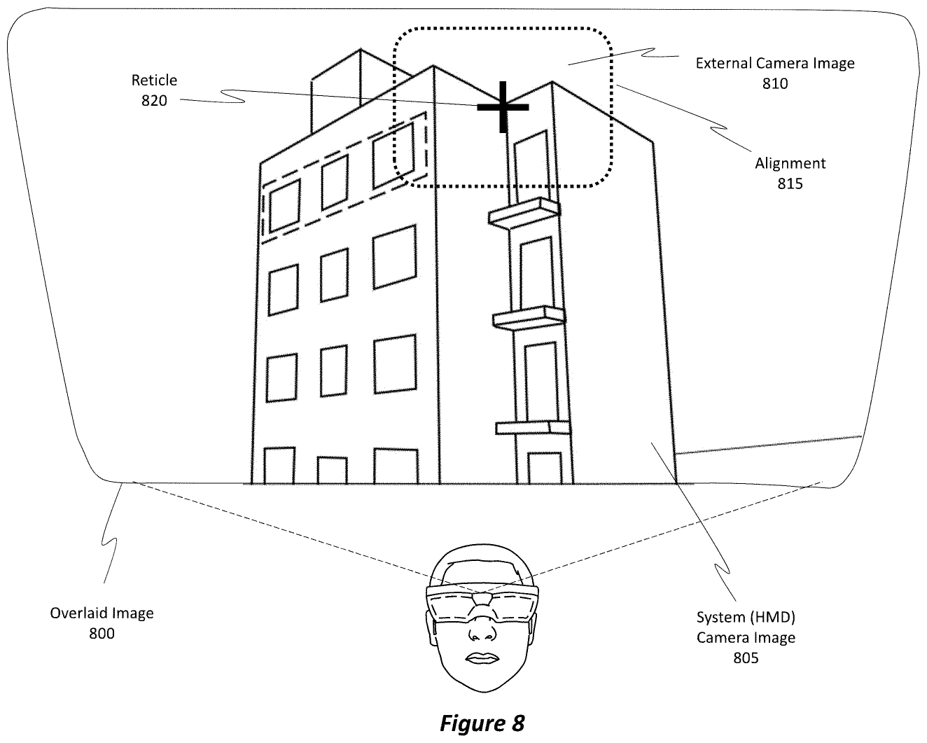

As another example, suppose the system camera is a low light camera and further suppose the external camera is a thermal imaging camera. As will be discussed in more detail later, the embodiments are able to selectively extract image content from the thermal imaging camera image and overlay that image content onto the low light camera image. In this regard, the thermal imaging content can be used to augment or supplement the low light image content, thereby providing enhanced imagery to the user. Additionally, because the external camera has increased resolution relative to the system camera, the resulting overlaid image will provide enhanced clarity for the areas where the pixels in the external camera image are overlaid onto the system camera image. FIG. 8 provides an example of these operations and benefits.

Image Correspondences And Alignment

In accordance with the disclosed principles, the embodiments are able to align the system camera's image with the external camera's image. That is, because at least a portion of the two cameras' FOVs overlap with one another, as was described earlier, at least a portion of the resulting images include corresponding content. Consequently, that corresponding content can be identified and then a merged, fused, or overlaid image can be generated based on the similar corresponding content. By generating this overlaid image, the embodiments are able to provide enhanced image content to the user, which enhanced image content would not be available if only a single image type were provided to a user. Both the system camera's image and the external camera's images may be referred to as “texture” images.

As described earlier, different techniques can be used to perform the alignment. One technique is the “visual alignment” technique involving the detection of feature points. Another technique is the IMU-based technique that aligns images based on determined poses of the respective cameras. The visual alignment technique usually produces more accurate results. Another technique is the hardware-based approach involving 6 DOF trackers and a range finder. More details on each technique will be provided herein.

Regarding the visual alignment technique, to merge or align the images, some embodiments are able to analyze the texture images (e.g., perform computer vision feature detection) in an attempt to find any number of feature points. As used herein, the phrase “feature detection” generally refers to the process of computing image abstractions and then determining whether an image feature (e.g., of a particular type) is present at any particular point or pixel in the image. Often, corners (e.g., the corners of a wall), distinguishable edges (e.g., the edge of a table), or ridges are used as feature points because of the inherent or sharp contrasting visualization of an edge or corner.

Any type of feature detector may be programmed to identify feature points. In some cases, the feature detector may be a machine learning algorithm. As used herein, reference to any type of machine learning may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In accordance with the disclosed principles, the embodiments detect any number of feature points (e.g., 1, 2, 3, 4, 5, 6, 7, 8, 9, 10, 20, 30, 40, 50, 60, 70, 80, 90, 100, 200, 500, 1,000, 2,000, or more than 2,000) and then attempt to identify correlations or correspondences between the feature points detected in the system camera image and the feature points identified in the external camera image.

Some embodiments then fit the feature or image correspondence(s) to a motion model in order to overlay one image onto another image to form an enhanced overlaid image. Any type of motion model may be used. Generally, a motion model is a type of transformation matrix that enables a model, a known scene, or an object to be projected onto a different model, scene, or object.

In some cases, the motion model may simply be a rotational motion model. With a rotational model, the embodiments are able to shift one image by any number of pixels (e.g., perhaps 5 pixels to the left and 10 pixels up) in order to overlay one image onto another image. For instance, once the image correspondences are identified, the embodiments can identify the pixel coordinates of those feature points or correspondences. Once the coordinates are identified, then the embodiments can overlay the external camera sight's image onto the HMD camera's image using the rotational motion model approach described above.

In some cases, the motion model may be more complex, such as in the form of a similarity transform model. The similarity transform model may be configured to allow for (i) rotation of either one of the HMD camera's image or the external camera sight's image, (ii) scaling of those images, or (iii) homographic transformations of those images. In this regard, the similarity transform model approach may be used to overlay image content from one image onto another image. Accordingly, in some cases, the process of aligning the external camera image with the system camera image is performed by (i) identifying image correspondences between the images and then, (ii) based on the identified image correspondences, fitting the correspondences to a motion model such that the external camera image is projected onto the system camera image.

Another technique for aligning images includes using IMU data to predict poses of the system camera and the external camera. Once the two poses are estimated or determined, the embodiments then use those poses to align one or more portions of the images with one another. Once aligned, then one or more portions of one image (which portions are the aligned portions) are overlaid onto the corresponding portions of the other image in order to generate an enhanced overlaid image. In this regard, IMUs can be used to determine poses of the corresponding cameras, and those poses can then be used to perform the alignment processes. IMU data is almost always readily available. Sometimes, however, the visual alignment process might not be able to be performed.

Details on the hardware-based approach will be provided later. Generally, the disclosed embodiments are able to use any of these techniques to align image content. Beneficially, the hardware-based approach can be performed essentially in real-time and can be performed even in conditions where the other approaches or techniques might fail.

FIG. 8 shows a resulting overlaid image 800 comprising portions (or all) of a system (HMD) camera image 805 (i.e. an image generated by the system camera) and an external camera image 810 (i.e. an image generated by the external camera). These images are aligned using an alignment 815 process (e.g., visual alignment, IMU-based alignment, and/or hardware-based alignment). Optionally, additional image artifacts can be included in the overlaid image 800, such as perhaps a reticle 820 used to help the user aim the tool. By aligning the image content, a user of the tool can determine where the tool is being aimed without having to look down the tool's sights. Instead, the user can discern where the tool is being aimed by simply looking at the content displayed in his/her HMD.

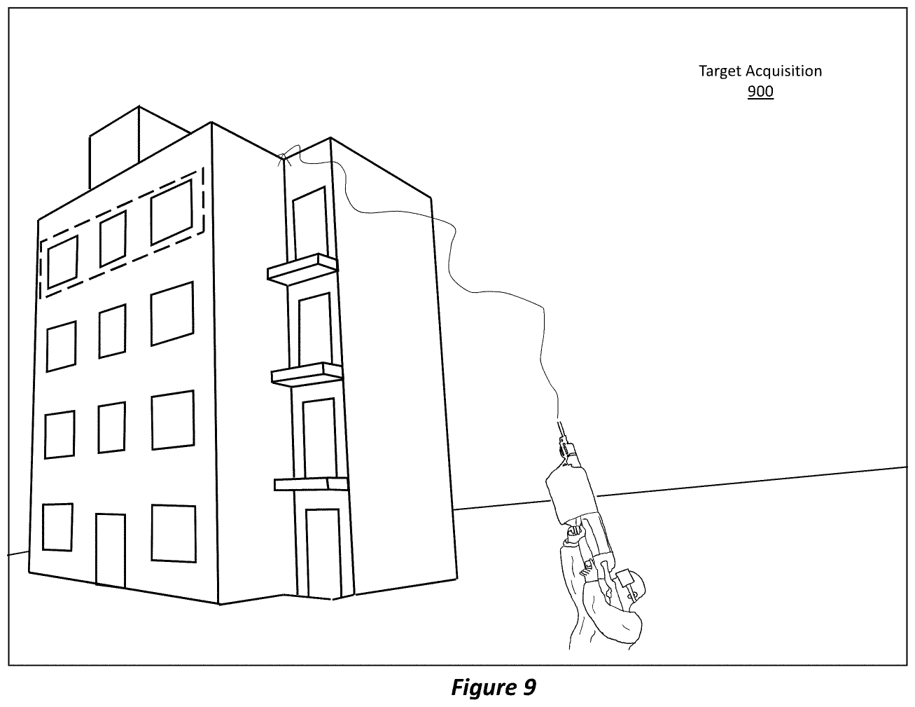

Providing the enhanced overlaid image 800 allows for rapid target acquisition, as shown by target acquisition 900 in FIG. 9. That is, a target can be acquired (i.e. the tool is accurately aimed at a desired target) in a fast manner because the user no longer has to take time to look through the tool's sights.

Visual Alignment Approach

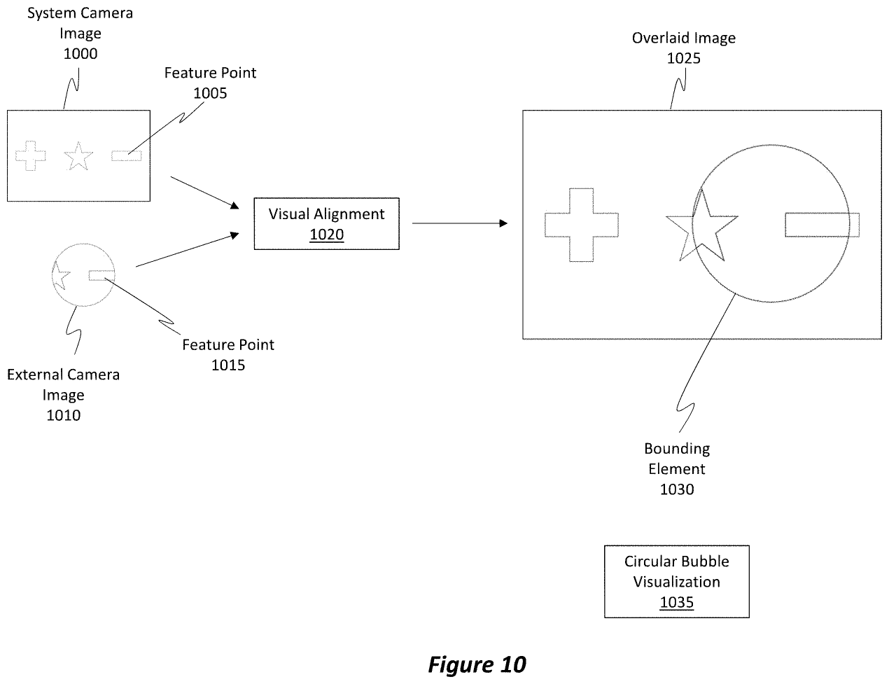

FIG. 10 shows an abstracted version of the images discussed thus far and is focused on the visual alignment approach. In particular, FIG. 10 shows a system camera image 1000 having a feature point 1005 and an external camera image 1010 having a feature point 1015 that corresponds to the feature point 1005. The embodiments are able to perform a visual alignment 1020 between the system camera image 1000 and the external camera image 1010 using the feature points 1005 and 1015 in order to produce the overlaid image 1025. The overlaid image 1025 includes portions extracted or obtained from the system camera image 1000 and portions extracted or obtained from the external camera image 1010. Notice, in some embodiments, the overlaid image 1025 includes a bounding element 1030 encompassing pixels that are obtained from the external camera image 1010 and/or from the system camera image 1000. Optionally, the bounding element 1030 may be in the form of a circular bubble visualization 1035. Other shapes may be used for the bounding element 1030, however.

IMU-Based Approach

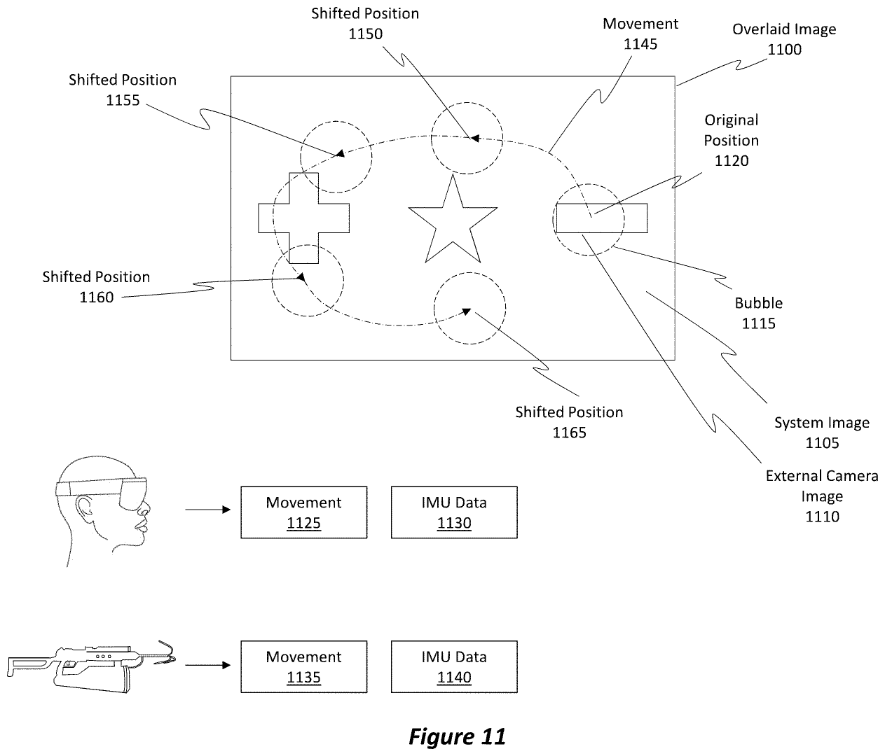

When the visual alignment process is not available, the embodiments can perform the IMU-based alignment process. FIG. 11 is representative.

FIG. 11 shows an overlaid image 1100, which is representative of the overlaid image 1025 from FIG. 10. For instance, it may be the case that at a first point in time, the embodiments performed the visual alignment technique. Thereafter (at least for a period of time), the embodiments performed the IMU-based technique, as shown in FIG. 11.

FIG. 11 shows how the overlaid image 1100 is formed from a system image 1105 and an external camera image 1110. The overlaid image 1100 also includes a bubble 1115 surrounding the content from the external camera image 1110. Notice, the bubble 1115 has an original position 1120. Based on movements of the HMD (e.g., movement 1125), which movements are detected by IMU data 1130 from the HMD's IMU, and based on movements of the external camera (e.g., movement 1135), which are detected by IMU data 1140 from the external camera's IMU, the embodiments are able to shift or relocate the bubble to new positions to reflect the movements of the HMD and external camera.

For instance, over a given period of time, there is relative movement 1145 between the HMD and the external camera, resulting in the bubble 1115 relocating to new positions, such as shifted position 1150 at one point in time, shifted position 1155 at another point in time, shifted position 1160 at another point in time, and shifted position 1165 at another point in time. These shifted positions were determined using the IMU data 1130 and 1140.

At another point in time, the option to perform visual alignment is now available (e.g., perhaps now a sufficient number of feature points are detectable). Accordingly, the embodiments are able to use a hybrid approach in which the visual alignment process and the IMU-based process are performed in order to generate an overlaid image and to relocate the bounding element based on detected movement.

Hardware-Based Approach

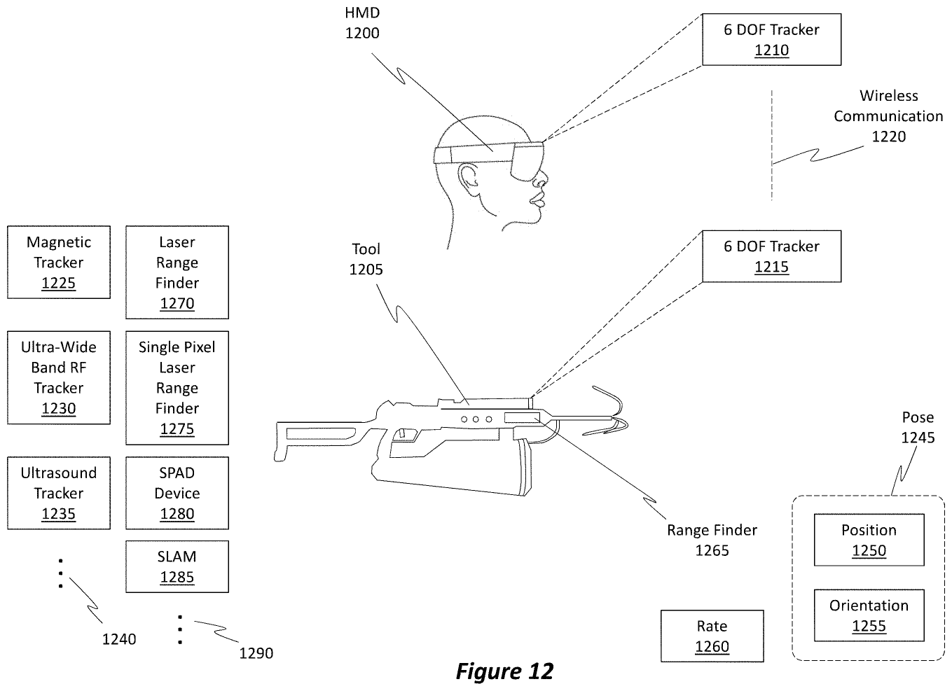

Having just described the visual approach and the IMU-based approach, attention will now be directed to FIG. 12, which illustrates the hardware-based approach. This approach can be performed essentially in real-time and can be performed even in conditions where the other approaches might fail (e.g., poor lighting conditions). Furthermore, the disclosed approach often produces results that are more accurate than the other approaches. Even further, the hardware-based approach allows for almost instantaneous corrections when parallax conditions change. For instance, suppose the external camera was initially pointed at an object far away, but then a person, who is near to the camera, walks in front of the camera. With the traditional approaches, a delay would be present in responding to the parallax, thereby leading to less accurate imagery. With the hardware-based approach, however, the parallax correction can be performed in real-time because of the use of the range finder, which is able to detect the change in depth and respond accordingly. Therefore, because of the high sample rates of the hardware disclosed herein, changes in conditions can be responded to in real-time or near real-time.

With that understanding, FIG. 12 shows an example HMD 1200, which is representative of the HMDs discussed thus far. HMD 1200 is equipped with a system camera, as discussed previously. FIG. 12 also shows a tool 1205, which is equipped with a detached (relative to the HMD 1200) external camera.

In accordance with the disclosed principles, the HMD 1200 (or perhaps the system camera itself) is also equipped with a 6 degree of freedom (DOF) tracker 1210. Similarly, the tool 1205 (or perhaps the external camera itself) is also equipped with a 6 DOF tracker 1215. The 6 DOF tracker 1210 and the 6 DOF tracker 1215 can communicate wirelessly with one another or, alternatively, the HMD 1200 and the tool 1205 can communicate wirelessly with on another. The wireless communication 1220 shows this ability to communicate wirelessly.

The 6 DOF trackers 1210 and 1215 can take on a variety of forms. For instance, in some implementations, the 6 DOF trackers can be a type of magnetic tracker 1225, a type of ultra-wide band radio frequency (RF) tracker 1230, or even an ultrasound tracker 1235. The ellipsis 1240 indicates that other types of 6 DOF trackers can be used as well. For instance, the 6 DOF trackers can be any type of non-image based trackers.

With the 6 DOF tracker 1210 and the 6 DOF tracker 1215, the embodiments are able to determine a position 1250 and orientation 1255 (collectively, a pose 1245) of the system camera and the external camera. The position 1250 and the orientation 1255 can optionally be an absolute position and orientation. A relative position and a relative orientation can then be determined based on the absolute positions and orientations. That is, the process of determining the relative position and orientation between the system camera and the detached external camera using the 6 DOF tracker of the system camera and the 6 DOF tracker of the external camera can be performed by first determining an absolute position and orientation of the system camera and an absolute position and orientation of the external camera and second determining the relative position and orientation based on the absolution positions and orientations. Additionally, or alternatively, the embodiments can directly determine the relative position and orientation without having to compute the absolute positions and orientations. Additionally, the relative position and orientation can be obtained by individual tracking of both cameras in a same world coordinate system. In some cases, the relative position and orientation can be measured by individual 6DOF tracking of both cameras. On the other hand, magnetic trackers can directly measure the 6DOF relative pose without explicitly tracking both cameras. This works by putting a sender on the external camera or tool and a receiver on the HMD or system camera.

The rate 1260 at which the embodiments use the 6 DOF trackers 1210 and 1215 to compute the position 1250 and the orientation 1255 can be set to any rate. Advantageously, the embodiments set the rate 1260 to coincide with the rate at which the embodiments generate images. For instance, the system camera often operates at a rate of about 60 FPS, or perhaps 90 FPS. The external camera often operates at a rate of about 30 FPS. The embodiments can set the rate 1260 of the trackers to 30 Hz, 60 Hz, 90 Hz, or even faster than 90 Hz. Stated differently, the process of determining the relative position and orientation and the process of obtaining a depth measurement can be performed at various rates, including a rate of at least 30 Hz (or perhaps a rate of 60 Hz, 90 Hz, 120 Hz, and so on).

In addition to the hardware 6 DOF trackers that are now included in the architecture, the embodiments also dispose or integrate a range finder 1265 onto the tool 1205 at or with the external camera. The range finder 1265 can be any type of range finder, examples of which are shown in FIG. 12.

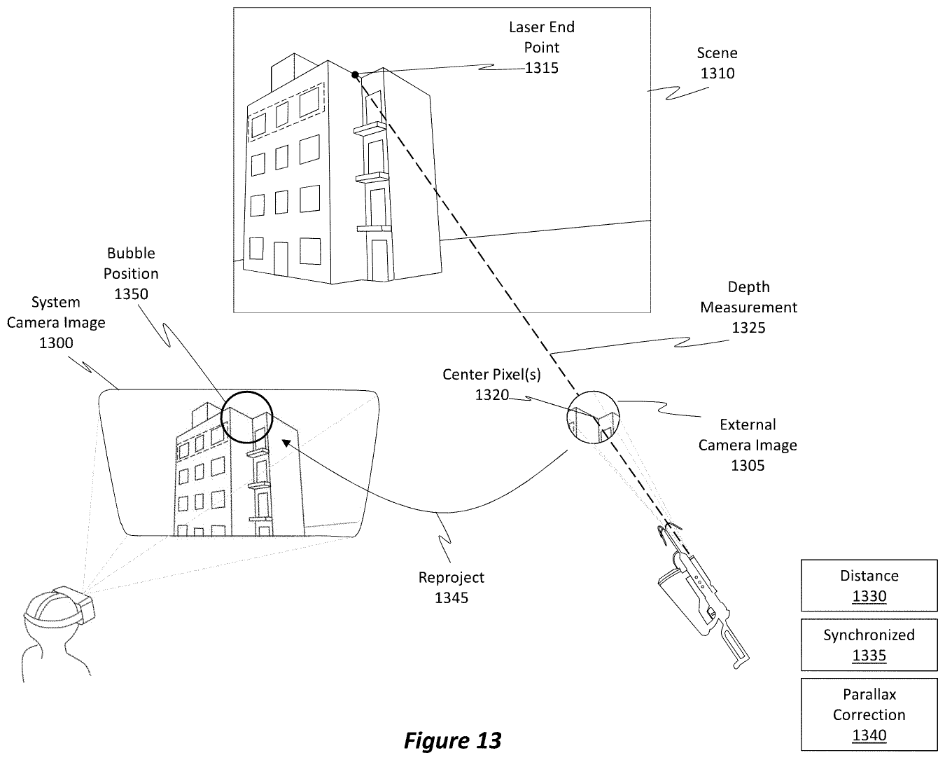

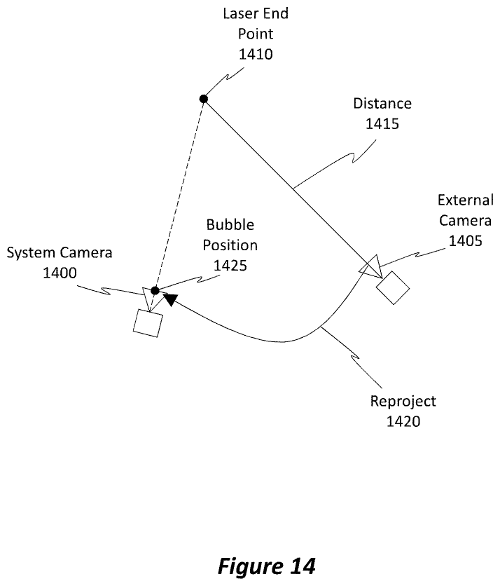

For example, the range finder 1265 can optionally be a laser range finder 1270, a single pixel laser range finder 1275, a single photon avalanche diode (SPAD) device 1280, a SLAM 1285 based system, or any other type of range finder, as illustrated by the ellipsis 1290. By way of further clarification, the tracker can be a simultaneous location and mapping (SLAM) based system. With such a system, both cameras share the same world coordinate system, which allows for the easy and efficient compute of their relative orientation and position. This can, for example, be accomplished by both cameras sharing the same map. The combination of the 6 DOF trackers 1210 and 1215 with the range finder 1265 enables the disclosed embodiments to accurately align image content using a non-visual based approach (e.g., there is no need to align feature points as is the case with the visual alignment process). FIGS. 13 and 14 provide further details.

FIG. 13 shows a system camera image 1300, which is generated by a system camera, and an external camera image 1305, which is generated by an external camera. Both of the cameras are directed towards a particular scene 1310, such as the building. In this respective, the field of view (FOV) of the external camera at least partially overlaps the FOV of the system camera.

In accordance with the disclosed principles, the external camera is associated with a range finder, and that range finder is also pointed or directed toward the scene 1310. To illustrate, the laser end point 1315 illustrates where the range finder is pointed. Notably, the laser end point 1315 also coincides with a set of one or more center pixel(s) 1320 of the resulting external camera image 1305. Stated differently, the range finder is aimed at a position so that the center pixel(s) 1320 of the external camera image 1305 are aimed at the terminal end of the laser or range finder.

With the range finder, the embodiments are able to compute a depth measurement 1325, or rather a distance 1330, between the external camera (and range finder) and the terminal end where the range finder is pointed at. In this scenario, the range finder and external camera are aimed at a corner of the building's roof. In other words, the optical axis of the external camera (which is also the center pixel(s) 1320) is aimed at the building edge. Likewise, the range finder is aimed at that same location. Consequently, the embodiments are able to determine the distance between the range finder/external camera and the object where the range finder is pointed (i.e. the terminal end or the laser end point 1315).

In addition to determining the distance 1330, the embodiments are able to use 6 DOF trackers on or with the system camera and the external camera. In some implementations, the 6 DOF trackers and the range finder are synchronized 1335 with one another so that they are triggered at the same time and so that they generate data having the same or substantially the same timestamp information.

Notably, with the use of the range finder, even if the scene changes suddenly (e.g., a new object appears closer than where the laser end point 1315 is currently located), the embodiments are able to perform parallax correction 1340 in a substantially real-time manner. That is, because the same rate of the range finder is relatively high (e.g., 30 Hz, or 60 Hz, or 90 Hz, or even more than 90 Hz), the range finder can determine new depths relatively quickly, and the system can respond to the parallax in a relatively fast manner.

With the 6 DOF trackers, the embodiments can determine the relative position and orientation of the system camera relative to the external camera. With the range finder, the embodiments can determine the distance between the external camera and whatever object the external camera is aimed at (i.e. where its optical axis or center pixel(s) 1320 are directed).

With the above information, the embodiments can now perform a non-visual based alignment process. That is, the embodiments can use the relative position and orientation information in combination with the depth measurement 1325 to reproject 1345 the external camera image 1305 onto the system camera image 1300 to thereby generate an overlaid image, as discussed previously. This reprojection process involves modifying the motion models of the cameras based on the 6 DOF information and based on the depth information. The motion models can be modified so enable an accurate reprojection process to occur, resulting in the external camera image 1305 being transformed, translated, and whatever other operation is needed in order to overlay and align content from the external camera image 1305 onto corresponding content from the system camera image 1300.

In addition to modifying the motion models to perform the reprojection, the embodiments are also able to generate and display a bubble, which is located at a particular bubble position 1350, on the resulting overlaid image. The bubble, or rather the bounding element, is displayed in a manner so as to encircle or bound the content from the external camera image 1305.

FIG. 14 illustrates an abstracted version of the subject matter that was presented in FIG. 13. Specifically, FIG. 14 shows a system camera 1400 and an external camera 1405. A range finder is used and is directed at an object in a scene. The laser end point 1410 illustrates the terminal end or terminal position where the range finder is pointed. The range finder can then determine the distance 1415 between itself (and thus the external camera 1405) and the laser end point 1410. The distance 1415 in combination with the determined relative position and orientation of the two cameras can then be used to modify the motion models of the cameras so as to reproject 1420 the resulting external camera image onto the system camera image. A bubble can then be displayed in the resulting overlaid image, where the bubble is displayed at a bubble position 1425, which is a position that surrounds or bounds the content from the external camera image.

Accordingly, the disclosed principles are focused on a hardware-based approach in which 6 DOF information and depth information are acquired from hardware devices. These pieces of information are then used to manipulate the motion models of the cameras in order to facilitate a reprojection process.

Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

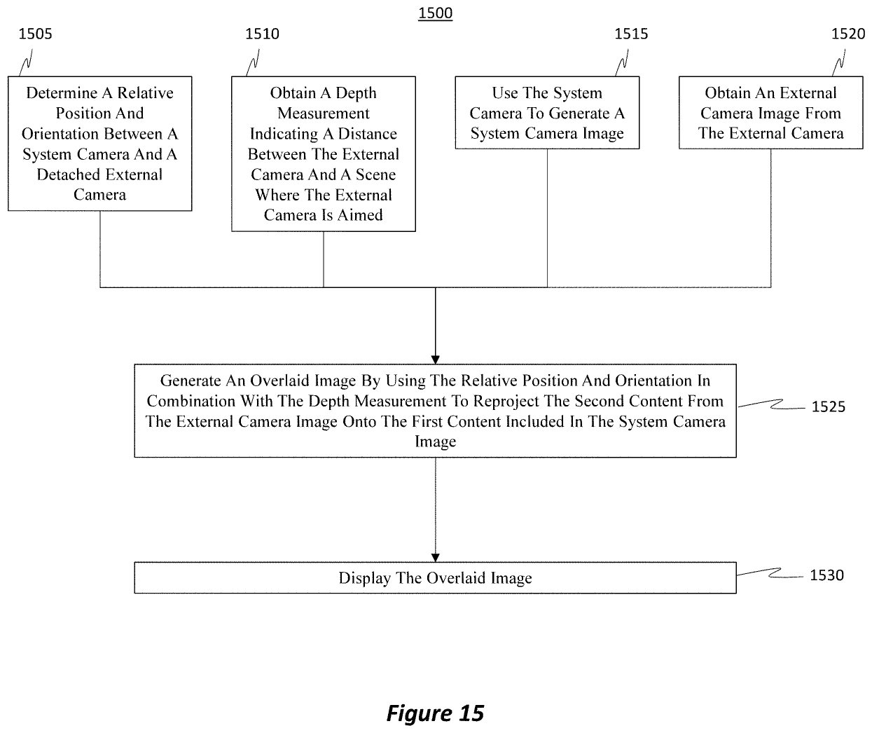

Attention will now be directed to FIG. 15, which illustrates a flowchart of an example method 1500 for determining a relative position and orientation between a system camera and an external camera. With that information, which is acquired from hardware devices, the embodiments can perform a non-visual based alignment process to align a system camera image with an external camera image. Method 1500 can be performed by any of the systems or HMDs (e.g., which include a system camera) mentioned thus far.

Method 1500 includes an act (act 1505) of determining a relative position and orientation between the system camera and a detached external camera. The process of determining the relative position and orientation is performed using a 6 degree of freedom (DOF) tracker on the system camera and a 6 DOF tracker on the external camera. Any of the 6 DOF trackers mentioned previously can be used. For example, the 6 DOF tracker on the system camera and the 6 DOF tracker on the external camera can both be magnetic trackers, ultra-wide band RF trackers, or even ultrasonic trackers. Additionally, it is typically the case that the two 6 DOF trackers (though conceivably there may be more than two 6 DOF trackers) are synchronized with one another.

Act 1510 involves obtaining a depth measurement indicating a distance between the external camera and a scene where the external camera is aimed. Act 1510 is performed in parallel with act 1505. That is, the process of obtaining the depth measurement can be performed in a synchronized manner with the process of determining the relative position and orientation of the two cameras. Stated differently, the process of determining the relative position and orientation between the system camera and the external camera can be synchronized with the process of obtaining the depth measurement. The process of obtaining the depth measurement can be performed using a laser range finder, a single pixel laser range finder, or even a SPAD device. Additionally, or alternatively, the process of obtaining the depth measurement can be performed via stereo triangulation to obtain stereo information. Here, the stereo information can be received as a result of using at least one additional camera or, alternatively, by using a previous frame.

In some cases, the process of obtaining the depth measurement indicating the distance between the external camera and the scene where the external camera is aimed is based on a center pixel of the external camera. Consequently, the distance is determined as between the external camera and whatever object the center pixel of the external camera is being aimed at.

In some cases, the depth measurement is obtained using a laser range finder that is mounted on or perhaps that is an integrated part of the external camera. The laser range finder can be disposed on the external camera at a location so that the laser range finder is aimed at whatever content is visible in a center set of one or more pixels of the external camera.

Some embodiments determine the relative position and orientation between the system camera and the external camera at a first rate (e.g., such as perhaps 30 Hz, 60 Hz, 90 Hz, and so on). These embodiments also use the system camera to generate the system camera image at a second rate. The second rate can be the same as the first rate (e.g., 30 Hz, 60 Hz, 90 Hz, and so on). In some cases, the second rate is different than the first rate. The embodiments also obtain the external camera image from the external camera at a third rate (e.g., the third rate is often lower than the second rate and is sometimes lower than the first rate) (e.g., about 30 Hz). In some implementations, the first rate is faster than the third rate. In some implementations, the first rate is the same as the third rate.

In parallel, or perhaps in serial with acts 1505 and 1510, act 1515 includes using the system camera to generate a system camera image. In parallel or in serial with acts 1505, 1510, and 1515, act 1520 involves obtaining an external camera image from the external camera. Optionally, a field of view (FOV) of the external camera can overlap a FOV of the system camera. As a consequence, first content included in the system camera image corresponds to second content included the external camera image. On the other hand, if the cameras do not overlap, then a subsequent reprojection of the external camera will simply be outside of the FOV of the system camera.

In some cases, the system camera generates the system camera image at a rate of at least 60 frames per second (FPS), and the external camera generates the external camera image at a rate of at least 30 FPS.

Act 1525 then includes generating an overlaid image by using the relative position and orientation in combination with the depth measurement to reproject the second content from the external camera image onto the first content included in the system camera image. In some cases, a bounding element can be added to the overlaid image, where the bounding element surrounds the second content (i.e. the content from the external camera image) in the overlaid image. Optionally, act 1530 involves displaying the overlaid image.

Beneficially, using the depth measurement to generate the overlaid image enables real-time parallax correction when changes in the scene occur. For instance, when a new object appears in the scene, where the external camera's optical axis or center pixels are aimed at that new object and where that new object is closer than whatever object the external camera was previously aimed at, the range finder can (in real time) compute a new depth measurement and can correct for parallax almost immediately because of the fast sample rate of the range finder.

Example Computer/Computer Systems

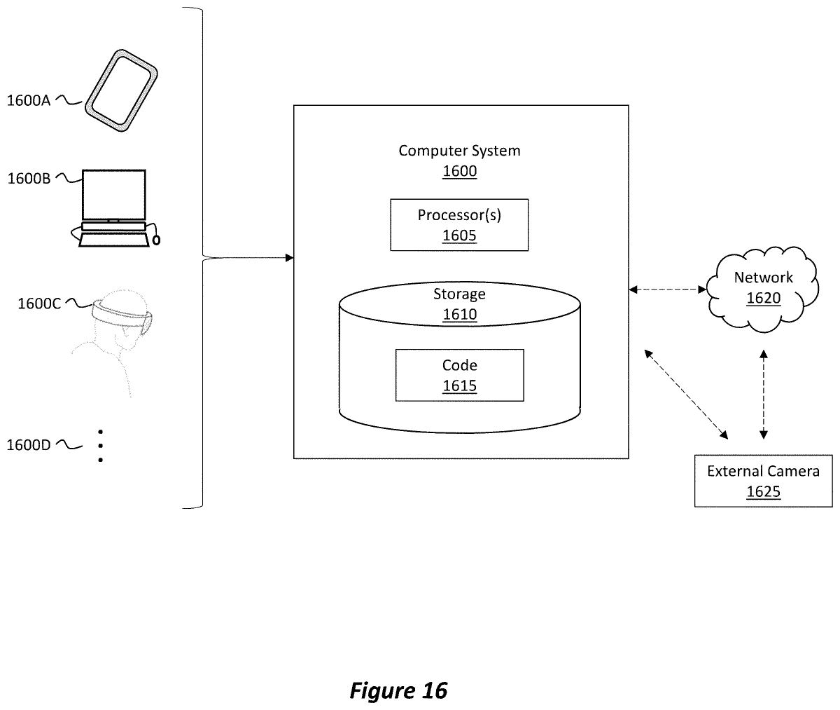

Attention will now be directed to FIG. 16 which illustrates an example computer system 1600 that may include and/or be used to perform any of the operations described herein. Computer system 1600 may take various different forms. For example, computer system 1600 may be embodied as a tablet 1600A, a desktop or a laptop 1600B, a wearable device 1600C (e.g., any of the HMDs discussed herein), a mobile device, or any other standalone device. The ellipsis 1600D illustrates how other form factors can be used. Computer system 1600 may also be a distributed system that includes one or more connected computing components/devices that are in communication with computer system 1600.

In its most basic configuration, computer system 1600 includes various different components. FIG. 16 shows that computer system 1600 includes one or more processor(s) 1605 (aka a “hardware processing unit”) and storage 1610.

Regarding the processor(s) 1605, it will be appreciated that the functionality described herein can be performed, at least in part, by one or more hardware logic components (e.g., the processor(s) 1605). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” or “engine” can refer to hardware processing units or to software objects, routines, or methods that may be executed on computer system 1600. The different components, modules, engines, and services described herein may be implemented as objects or processors that execute on computer system 1600 (e.g. as separate threads).

Storage 1610 may be physical system memory, which may be volatile, non-volatile, or some combination of the two. The term “memory” may also be used herein to refer to non-volatile mass storage such as physical storage media. If computer system 1600 is distributed, the processing, memory, and/or storage capability may be distributed as well.

Storage 1610 is shown as including executable instructions 1615. The executable instructions 1615 represent instructions that are executable by the processor(s) 1605 of computer system 1600 to perform the disclosed operations, such as those described in the various methods.

The disclosed embodiments may comprise or utilize a special-purpose or general-purpose computer including computer hardware, such as, for example, one or more processors (such as processor(s) 1605) and system memory (such as storage 1610), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 1600 may also be connected (via a wired or wireless connection) to external sensors (e.g., one or more remote cameras) or devices via a network 1620. For example, computer system 1600 can communicate with any number devices (e.g., external camera 1625 such as an external camera) or cloud services to obtain or process data. In some cases, network 1620 may itself be a cloud network. Furthermore, computer system 1600 may also be connected through one or more wired or wireless networks to remote/separate computer systems(s) that are configured to perform any of the processing described with regard to computer system 1600.

A “network,” like network 1620, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 1600 will include one or more communication channels that are used to communicate with the network 1620. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system configured to determine a relative position and orientation between a system camera and an external camera, said computer system comprising:
a system camera;
one or more processors; and
one or more computer-readable hardware storage devices that store instructions that are executable by the one or more processors to cause the computer system to:
determine a relative position and orientation between the system camera and a detached external camera;
obtain a depth measurement indicating a distance between the external camera and a scene where the external camera is aimed;
use the system camera to generate a system camera image;
obtain an external camera image from the external camera; and
generate an overlaid image by using the relative position and orientation in combination with the depth measurement to reproject the second content from the external camera image onto the first content included in the system camera image.

2. The computer system of claim 1, wherein a 6 degree of freedom (DOF) tracker on the system camera and a 6 DOF tracker on the external camera are both magnetic trackers and are used to determine the relative position and orientation.

3. The computer system of claim 1, wherein a 6 degree of freedom (DOF) tracker on the system camera and a 6 DOF tracker on the external camera are one of ultra-wide band radio frequency (RF) trackers or simultaneous location and tracking (SLAM) based trackers and are used to determine the relative position and orientation.

4. The computer system of claim 1, wherein obtaining the depth measurement is performed using a laser range finder.

5. The computer system of claim 1, wherein obtaining the depth measurement is performed using a single pixel laser range finder.

6. The computer system of claim 1, wherein obtaining the depth measurement is performed via stereo triangulation to obtain stereo information, the stereo information being received as a result of using at least one additional camera or, alternatively, by using a previous frame.

7. The computer system of claim 1, wherein a bounding element is added to the overlaid image, the bounding element surrounding the second content in the overlaid image.

8. The computer system of claim 1, wherein determining the relative position and orientation between the system camera and the external camera is synchronized with obtaining the depth measurement.

9. The computer system of claim 1, wherein:
determining the relative position and orientation between the system camera and the external camera is performed at a first rate,
using the system camera to generate the system camera image is performed at a second rate,
obtaining the external camera image from the external camera is performed at a third rate, and
the first rate is faster than the third rate.

10. The computer system of claim 1, wherein the system camera generates the system camera image at a rate of at least 60 frames per second (FPS), and wherein the external camera generates the external camera image at a rate of at least 30 FPS.

11. A method for determining a relative position and orientation between a system camera and an external camera, said method comprising:
determining a relative position and orientation between a system camera and a detached external camera;
obtaining a depth measurement indicating a distance between the external camera and a scene where the external camera is aimed;
using the system camera to generate a system camera image;
obtaining an external camera image from the external camera; and
generating an overlaid image by using the relative position and orientation in combination with the depth measurement to reproject the second content from the external camera image onto the first content included in the system camera image.

12. The method of claim 11, wherein obtaining the depth measurement indicating the distance between the external camera and the scene where the external camera is aimed is based on a center pixel of the external camera such that the distance is determined as between the external camera and whatever object the center pixel of the external camera is being aimed at.

13. The method of claim 11, wherein use of the depth measurement to generate the overlaid image enables real-time parallax correction when changes in the scene occur.

14. The method of claim 11, wherein a 6 degree of freedom (DOF) tracker on the system camera and a 6 DOF tracker on the external camera are both ultrasound trackers and are used to determine the relative position and orientation.

15. The method of claim 11, wherein determining the relative position and orientation between the system camera and the detached external camera is performed using a 6 degree of freedom (DOF) tracker of the system camera and a 6 DOF tracker of the external camera and is performed by first determining an absolute position and orientation of the system camera and an absolute position and orientation of the external camera and second determining the relative position and orientation based on the ab solution positions and orientations.

16. The method of claim 11, wherein a 6 degree of freedom (DOF) tracker on the system camera and a 6 DOF tracker on the external camera are both non-image based trackers.

17. The method of claim 11, wherein determining the relative position and orientation and obtaining the depth measurement are performed at a rate of at least 30 Hz.

18. A head mounted device (HMD) configured to determine a relative position and orientation between a system camera and a detached external camera, said HMD comprising:
a system camera;
one or more processors; and
one or more computer-readable hardware storage devices that store instructions that are executable by the one or more processors to cause the HMD to:
determine a relative position and orientation between the system camera and a detached external camera;
obtain a depth measurement indicating a distance between the external camera and a scene where the external camera is aimed;
use the system camera to generate a system camera image;
obtain an external camera image from the external camera;
generate an overlaid image by using the relative position and orientation in combination with the depth measurement to reproject the second content from the external camera image onto the first content included in the system camera image; and
display the overlaid image.

19. The HMD of claim 18, wherein the relative position and orientation is obtained by individual tracking of both cameras in a same world coordinate system.

20. The HMD of claim 19, wherein the laser range finder is disposed on the external camera at a location so that the laser range finder is aimed at whatever content is visible in a center set of one or more pixels of the external camera.
